(19) United States
(12) Patent Application Publication
(10) Pub. No.: US 2025/0020483 A1
(43) Pub. Date: Jan. 16, 2025

(54) SEMANTIC MAP UPDATING AND OBJECT SEARCHING USING IOT DEVICE CAMERAS

(71) Applicant: LENOVO (SINGAPORE) PTE. LTD., SINGAPORE (SG)

(72) Inventors: Song Wang, Morrisville, NC (US); Mengnan Wang, Morrisville, NC (US); Kevin W Beck, Morrisville, NC (US); Russell S VanBlon, Morrisville, NC (US)

(21) Appl. No.: 18/350,333

(22) Filed: Jul. 11, 2023

(51) Int. Cl. G01C 21/00; G01C 21/36

(52) U.S. Cl. CPC G01C 21/3856; G01C 21/3623

(57) ABSTRACT

In one aspect, a first device includes a processor assembly and storage accessible to the processor assembly. The storage includes instructions executable by the processor assembly to access a semantic map, receive input from a first camera on an Internet of things (IoT) device, and update the semantic map based on the input.

### FIELD

The disclosure below relates to technically inventive, non-routine solutions that are necessarily rooted in computer technology and that produce concrete technical improvements. In particular, the disclosure below relates to techniques for updating a semantic map using one or more Internet of things (IoT) device cameras.

### BACKGROUND

As recognized herein, electronic semantic maps can indicate the three-dimensional (3D) locations of various real-world objects within a real-world space. However, as also recognized herein, those objects might move or change over time, and real-time electronic tracking of those objects is typically not possible without attaching an electronic tracking tag like a GPS tag to each object. But this is often times not feasible or scalable. Moreover, even when used, using electronic tags can lead to undue constraints on processing resources and too much power being consumed in the tracking. But failure to use such tags can lead to the semantic map becoming outdated relatively fast. There are currently no adequate solutions to the foregoing computer-related, technological problem.

### SUMMARY

Accordingly, in one aspect a first device includes a processor assembly and storage accessible to the processor assembly. The storage includes instructions executable by the processor assembly to access a semantic map and receive input from a first camera on an Internet of things (IoT) device. The instructions are also executable to update, based on the input, the semantic map.

In certain example implementations, the instructions may be executable to command the IoT device to provide the input responsive to at least one trigger. In various examples, the trigger may include a recurring period of time ending, receipt of a user command to update the semantic map, and/or a determination using object recognition that part of a real-world space represented in the semantic map has changed.

Additionally, in some examples the instructions may be executable to, during creation of the semantic map, identify one or more real-world devices that each include a camera. The one or more real-world devices may include the IoT device. The instructions may then be executable to save data indicating the one or more real-world devices that each include a camera and use the data to command the IoT device to provide the input.

Also, if desired the instructions may be executable to present a user interface (UI), where the UI indicates an object in the semantic map that has not been identified via object recognition. In these examples, the instructions may then be executable to receive user input indicating a label for the object and update the semantic map with the label. So, for example, the instructions may be executable to present a prompt for a user to use a second camera to capture images of the object from different angles, receive the images of the object and generate three-dimensional (3D) data for the object based on the images, and update the semantic map with the 3D data. The second camera may be the same as or different from the first camera. The UI may include a graphical user interface and/or an audible user interface.

In various example implementations, the first device may even include the camera. Also in various example implementations, the first device may be the same as or different from the IoT device.

In another aspect, a method includes accessing, via a first device, a semantic map. The method also includes receiving input from a first camera on a second device and updating the semantic map based on the input.

In certain examples, the second device may be an Internet of things (IoT) device. E.g., the IoT device may include a television, a smartphone, a tablet computer, a laptop computer, a headset, a stand-alone camera, a digital assistant device, a cooking appliance, an electronic door lock, and/or an electronic doorbell.

If desired, in various example implementations the method may include updating the semantic map using one or more cameras at recurring periods of time.

In still another aspect, at least one computer readable storage medium (CRSM) that is not a transitory signal includes instructions executable by a processor assembly to access a semantic map, receive input from a first camera on a device accessible to the at least one processor, and update, based on the input, the semantic map.

Thus, in certain examples the instructions may be executable to request a label from a user for an object that cannot be recognized via object recognition, where the object is represented in the semantic map. Here the instructions may also be executable to receive user input indicating the label and update the semantic map with the label.

Also, if desired in various example embodiments the instructions may be executable to trigger the first camera to generate the input for updating the semantic map, where the first camera may be triggered responsive to user command and/or a recurring period of time ending.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is an illustration of an example real-world space that is semantically mapped consistent with present principles;

FIG. 3 shows an example graphical user interface (GUI) that includes a semantic map and a list of unidentified objects for which the user may create semantic map labels consistent with present principles;

FIGS. 4 and 5 show example GUIs that may be used during a scanning process to generate more 3D data for an object that is to be included in a semantic map consistent with present principles;

FIG. 6 shows an example GUI with a prompt asking a user to move a device camera to a different location to map additional portions of a space for representation in a semantic map consistent with present principles;

FIGS. 7 and 8 show different example GUIs that may be used to locate a real-world object within a space via a semantic map consistent with present principles;

FIG. 9 shows an example GUI that may be used to place a new object within the space using a semantic map consistent with present principles;

FIG. 10 illustrates example logic in example flow chart format that may be executed by a device consistent with present principles; and

FIG. 11 shows an example settings GUI that may be presented on a display to configure one or more settings of a device to operate consistent with present principles.

### DETAILED DESCRIPTION

Among other things, the detailed description below allows for electronically tracking real-world objects over time and also placing real-world objects at designated locations when a user is unfamiliar with a space. Thus, systems and methods for tracking and placement are provided for both electronic/trackable objects and non-electronic objects that are located in a mappable space.

Accordingly, in one particular aspect, principles set forth below can be used for tracking and placement of an object via semantic mapping and user-assisted/intuitive labeling of objects of importance. Mapping of a space may be accomplished through scanning via cameras to create a point cloud for various objects as well as 3D coordinates for the objects/points in the cloud themselves. Additionally, object recognition and/or other artificial intelligence (AI)-based systems can be used with the scanning process such that objects may be identified from a data training set as part of the scan and then labelled accordingly inside the space/map to achieve semantic understanding. Thus, the AI-enhanced semantic map may not only create a 3D feature-rich map but also contain data like instances of objects recognized, their names, and their respective locations inside the mappable space. Utilizing semantic understanding, a device may thus be used to track and place objects relevant to the user.

For instance, the following approach may be used in non-limiting embodiments. For object recognition, semantic mapping technology that includes a predefined database of trained objects for recognition may be used. If an object to be identified is already included in the database, its information may be autonomously included in the semantic map.

For objects that are not recognized autonomously, user-specified objects and labels can be added through intuitive means before/during/after the time of space mapping. A purpose-designed application/UI as well as voice commands input through appropriate devices can therefore be leveraged for model scanning and processing to add to the existing database of recognized objects with a user's labels. The semantic map can then be further updated as new objects are scanned, trained, and recognized at any stage of the mapping process. Objects added pre-mapping may be used to improve an already-created database of objects that can be recognized, and objects scanned and labeled during mapping can be added in real time to the semantic map as it forms. Objects added to the database after the semantic map has been created can further update the semantic understanding of the existing map.

Sensor fusion may also be used for the updated map. Thus, sensor fusion may be used to allow multiple devices with cameras and/or IMU sensors and that are within the mappable space to constantly or periodically update the map. This might be particularly useful for spaces such as homes and offices where objects of importance to a user might not always stay stationary. Accordingly, sensors from an AR glass, indoor camera, mobile phones, etc. can be used to work together and scan the space at different angles and times. The computations can then be offloaded via the cloud for a server to process (and/or processed locally), and therefore each device's scanned data and time stamps can be analyzed to create a “real time” version of the semantic map of the space that contains all the relevant objects and their relative locations inside the space.

Present principles may also be used to locate particular real-world objects within the mappable space. For instance, to locate an object, the user can use a purpose-designed application or voice command to locate the object if it exists in the semantic map's object recognition database. Additionally, since the semantic map for the space can contain data of unrecognized objects and their respective locations in its feature map, the user can also sort through images of objects derived from the map through the purposed-designed application to look for untrained/unrecognized objects and their last known locations. Voice recognition of an oral description of the object as provided by the user can also be used further narrow down this search.

Present principles may also be used to help with real-world object placement via map route planning. Route planning inside a mappable space is possible for recognized/mapped objects and so a map created for a space can be visually presented to the user through the purpose-built viewing application so that user can then place objects recognized by the semantic map at preferred location inside that map. Utilizing any AR/mobile device that has access to the semantic map, a navigational path may therefore be created from the AR/mobile device's current location to the desired location for each object for placement by the user at the designated location. This might be particularly useful when a user wants to place objects inside an unfamiliar space but needs help navigating, and as such might be used by moving companies, cleaners, etc.

What's more, note that hardware that may be used to implement present principles in some example instances might include only fisheye cameras and IMUs that already reside in the mobile phone and/or head-mounted display, reducing hardware infrastructure and processing constraints that might otherwise burden implementation of present principles.

Thus, present principles may be used to locate objects easily and intuitively at their last known locations, and/or to place objects correctly in a space unfamiliar to the user through semantic mapping.

Accordingly, in non-limiting examples, a semantic map may be generated using SLAM (and/or other mapping technologies for 3D electronic space mapping), where the SLAM map is enhanced with object recognition capability (e.g., object name/type tags) in the map to render a semantic map. Each recognized object in the semantic map may have known coordinates within the map, and the map may be searchable by object to locate the object within the map.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

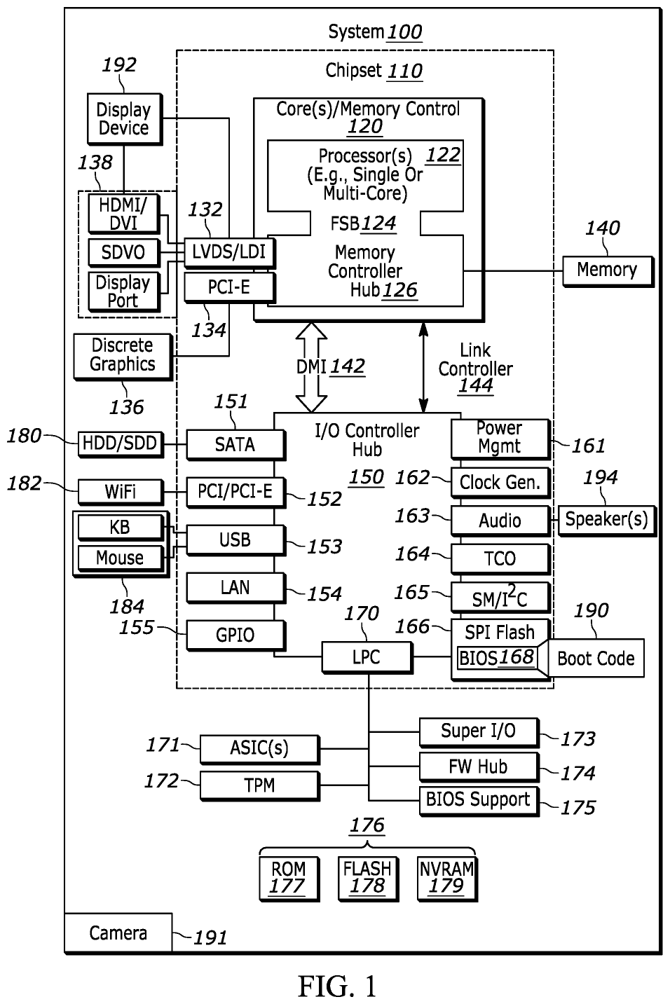

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor assembly 122 (e.g., one or more single core or multi-core processors, etc.) and a memory controller hub 126 that exchange information via a front side bus (FSB) 124. A processor assembly such as the assembly 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include a camera 191. The camera 191 may gather one or more images and provide the images and related input (e.g., metadata like an image timestamp) to the processor assembly 122. The camera may be a thermal imaging camera, an infrared (IR) camera, a digital camera such as a webcam, a three-dimensional (3D) camera, and/or a camera otherwise integrated into the system 100 and controllable by the processor assembly 122 to gather still images and/or video.

Additionally, though not shown for simplicity, in some embodiments the system 100 may include a gyroscope that senses and/or measures the orientation of the system 100 and provides related input to the processor assembly 122, an accelerometer that senses acceleration and/or movement of the system 100 and provides related input to the processor assembly 122, and/or a magnetometer that senses and/or measures directional movement of the system 100 and provides related input to the processor assembly 122. These three components may form part of an inertial measurement unit (IMU) in certain examples, where the IMU may be used in conjunction with one or more cameras (like the camera 191) to generate a three-dimensional (3D) point cloud and/or map of an area using simultaneous localization and mapping (SLAM) and/or other techniques consistent with present principles. Thus, coordinates for different objects and other 3D real-world features may be stored as part of the map. Object recognition may then be executed using the images to identify the names and/or object types for various objects recognized from the area via the camera input. The names and/or types may then be used as labels to label various objects shown in the point cloud/SLAM map to thus render a semantic map that indicates both 3D visual appearances and locations for the objects as well as tags corresponding to the labels identifying the objects.

Still further, the system 100 may include an audio receiver/microphone that provides input from the microphone to the processor assembly 122 based on audio that is detected, such as via a user providing audible input to the microphone. Also, the system 100 may include a global positioning system (GPS) transceiver that is configured to communicate with satellites to receive/identify geographic position information and provide the geographic position information to the processor assembly 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

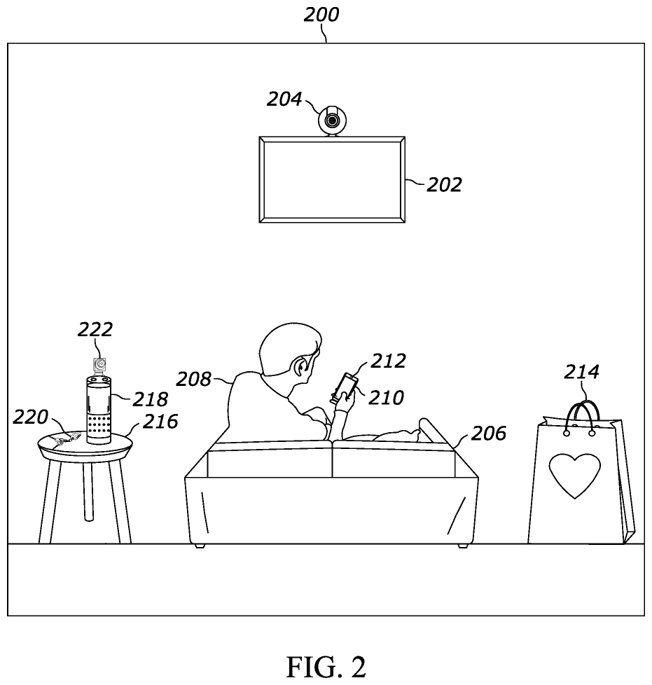

Turning now to FIG. 2, an example real-world area 200 is shown, which in this case is a living room of a personal residence. Shown in the area 200 are a television 202 with a built-in camera 204, a couch 206, a user 208 holding a smartphone 210 with camera 212, and a gift bag 214. Also shown is a coffee table 216, a stand-alone digital assistant device 218 sitting on top of the table 216 (e.g., an Amazon Alexa device, Google Assistant, or a Lenovo Assistant device), and a set of car keys 220. Note that the device 218 may have its own camera 222.

Also note that the TV 202, smartphone 210, assistant device 218, and any other electronic smart devices in the area 200 may communicate over a network such as a Wi-Fi network, the Internet, a Bluetooth network, an ultra-wideband network, etc. in accordance with present principles. It is to also be understood that each of these devices may include at least some of the features, components, and/or elements of the system 100 described above. Indeed, any of the devices disclosed herein may include at least some of the features, components, and/or elements of the system 100 described above. Also note that these devices may communicate with an Internet-based cloud storage server accessible to the devices within the area 200 so that the devices in the area 200 can access a semantic map and/or other data described below as stored at the server, depending on implementation. The semantic map and/or other data may additionally or alternatively be stored at one of the devices 202, 210, 218, or other local device themselves.

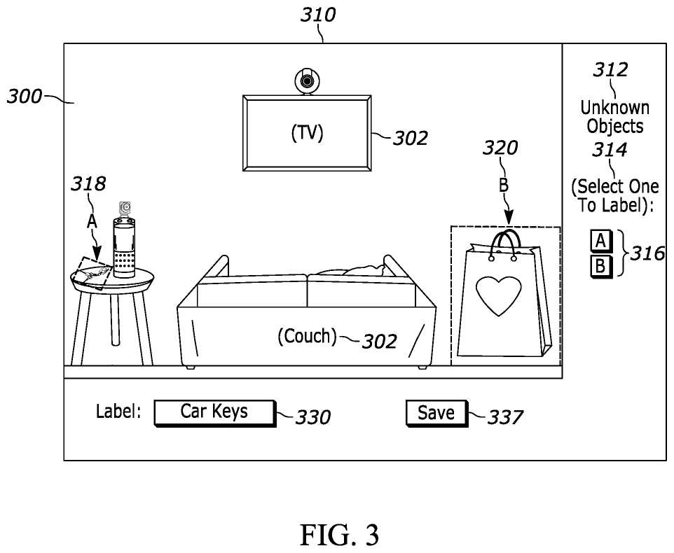

Turning now to FIG. 3, an example illustration of a semantic map 300 is shown. As described above in reference to FIG. 1, the semantic map may be generated by first creating a SLAM map. Creating a SLAM map may involve using cameras imaging the area 200 from different angles to thus generate 3D point/feature data from the area 200. Object recognition-generated labels 302 may then be added to the SLAM map to render the 3D semantic map 300. The labels may therefore be stored as metadata for the 3D semantic map 300 and/or be included as part of the map 300 itself. In either case, the labels may be rendered over the associated object itself as the person views the semantic map on a display of a device such as a laptop, smartphone, or even augmented or virtual reality headset.

As also shown in FIG. 3, the semantic map 300 is presented as part of a graphical user interface (GUI) 310 presented on a display. In addition to including the map 300, the GUI 310 includes a list 312 of one or more objects that the device/system was unable to recognize during generation of the semantic map 300. The list 312 is accompanied by a prompt 314 for an end-user to select one of the items from the list 312 to label the associated object with a user-generated label. FIG. 3 therefore shows that objects generally designated as objects “A” and “B” are included in the list 312, and graphical indicators 318, 320 for each respective object are also overlaid on the semantic map 300 to show the user both a visual image of the object and its relative location within the map 300 (and hence area 200 itself). Note that the indicators 318, 320 include not just corollary “A” and “B” designations for the respective objects but also respective arrows pointing to the respective objects in the map 300 to further highlight them to the user.

The user may thus pick and choose some or all of the objects from the list for which to provide/generate labels. Note that the user might only choose to label objects that the user considers important in certain non-limiting embodiments, since labeling each and every computer-unknown object from a given area might be tedious and not altogether necessary.

In any case, responsive to touch or voice input to select one of the items 316 from the list 312 or map 300 itself as presented on the device display, a text input field 330 may be rendered and/or selected for a user to then enter the user's desired label for the selected object. The user may then use voice input, a hard or soft keyboard, or other input means to enter the user-designated label into the input field 330. The user may then select the save selector 332 to save the entered label and apply the label to the object in the map 300 itself so that the map/map metadata indicates the user-designated label for the associated object. In the present instance, the user has labeled object “A” as “car keys”.

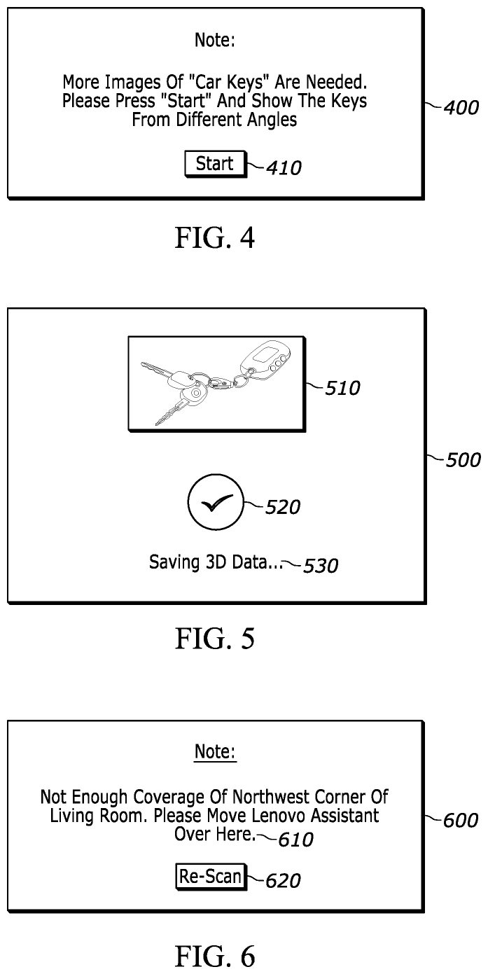

Now suppose the system does not currently have enough 3D data on the car keys in the semantic map 300 for the keys to be rendered at different angles in the map 300 and/or identified from different angles and locations. FIG. 4 shows that a prompt 400 may be presented on the display of the user's device. As shown, the prompt 400 may indicate that more images of “car keys” are being requested by the system. The prompt 400 may further instruct the user to press the start selector 410 and then show the keys to the user's smartphone camera (or another device camera) from different angles. Thus, the user might select the start selector 410 and then hold the keys up to his/her smartphone camera and then rotate the keys around 360 degrees in both the horizontal and vertical planes within the camera's field of view for the system/smartphone to generate a 3D point cloud of the keys for recognition of the keys in the future (e.g., inclusion of those 3D points/features into the map 300 itself).

FIG. 5 thus shows another GUI 500 that may be presented during this process of generating digital 3D points for the key for inclusion in the semantic map 300 (e.g., responsive to selection of the start selector 410). As shown, a viewfinder 510 of the current live feed from the smartphone camera is shown, with the live feed showing the keys 220. Responsive to the system/smartphone having enough data points on the keys based on the user's rotation of the keys in front of the smartphone camera as discussed above, the GUI 500 may change to include a green check mark 520 indicating that enough 3D points have been identified to successfully identify the keys 220 at a later time using IoT device cameras (e.g., regardless of viewing angle to the keys and orientation of the keys themselves). An indication 530 may also be presented indicating that the 3D point cloud data for the keys is being saved (e.g., as part of the 3D semantic map).

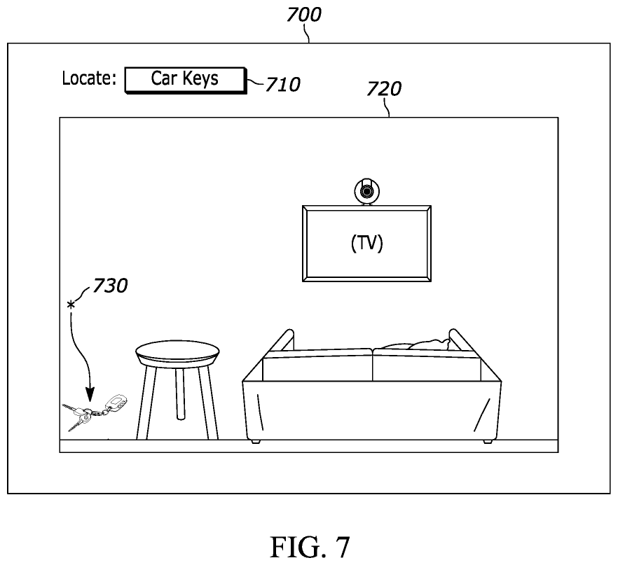

Now suppose that while the map 300 itself is initially generated, or upon updating of the map, a certain portion of the area 200 represented in the map 300 does not have enough camera coverage (e.g., none of the cameras described above in reference to FIG. 2 currently show that portion of the area 200 in their field of view (FOV)). This can lead to a hole in the semantic map 300 where no or an insufficient amount of 3D data points exist. FIG. 6 therefore shows a GUI 600 that may be presented in this situation.

As shown in FIG. 6, the GUI 600 may include a prompt 610 that not enough image/camera coverage exists of the northwest corner of the living room area 200. The prompt 610 may also instruct the end-user to move the Lenovo Assistant device 218 or another device with a camera over toward the northwest corner to image that portion of the area 200. Once the user has done so, the user may select the selector 620 to command the device/system to generate images of the northwest corner and use those images to generate 3D feature data of the corner for inclusion in the SLAM map/semantic map itself.

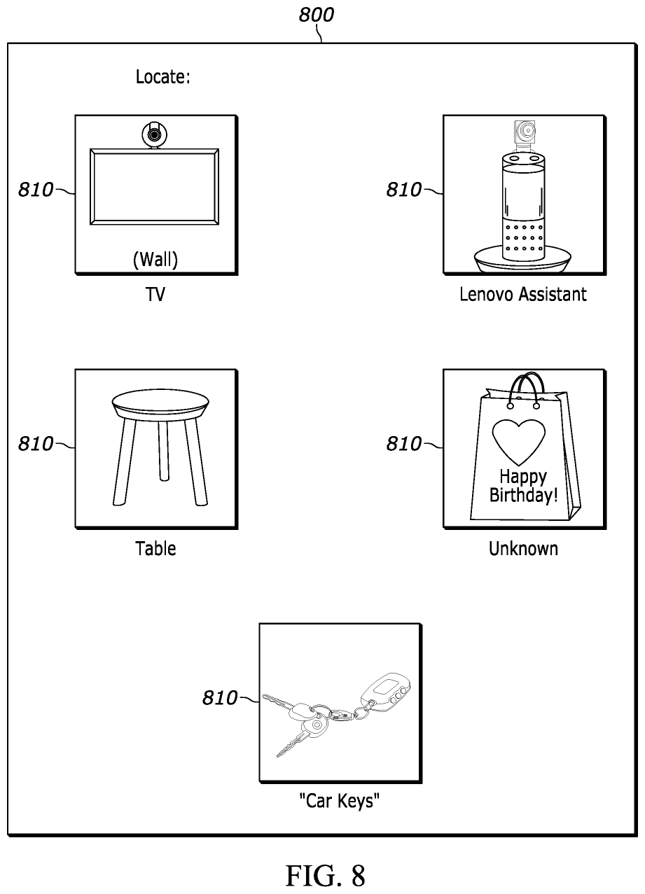

Now suppose that, at a later time, the user is going to leave his/her house but cannot find the keys 220. The user may open an application (“app”) such as a semantic map app, IoT device map, home user experience (UX) app, etc. to help him/her locate the keys 220 using the map 300 itself. Thus, responsive to the app being opened or based on navigation of other screens within the app, the GUI 700 of FIG. 7 may be presented. As shown, the GUI 700 may include a text input field 710 into which the user may enter the name (label) of the object he/she is seeking to locate, either through voice input or text input or other type of input. In the present example, the user has entered “car keys”.

FIG. 7 also shows that a real-time version 720 of the semantic map 300 may be presented as part of the GUI 700. The real-time version 720 may be an updated semantic map derived from the map 300 but with certain object representations moved within the updated semantic map 720 to locations within the map 720 corresponding to the current real-world locations of the corresponding real-world objects themselves as may have been identified using IoT device cameras (e.g., using live feeds from one or more of the cameras 204, 212, and/or 222). Note that the semantic map 720 may be presented on the display at an angle/FOV matching the current angle/FOV of the user themselves according to the user's current position and viewing angle into the real-world space itself (which may be determined using ultrawideband location tracking, IMU input and dead reckoning, GPS, etc.). Thus, based on the user entering the desired object into the field 710 to locate it, which might be the car keys or even another object for which the user did not specify a user-specific label themselves, the GUI 700 may be updated to include a graphical indication 730 in the form of a star and arrow pointing toward the current location of the keys 220 according to the user's current perspective so that the user may easily locate the keys in the real-world. In the present instance, the keys 220 have fallen off the table 216 and are sitting underneath it as represented in the updated semantic map 720 itself.

As another example means to help locate the keys 220, in addition to or in lieu of the GUI 700, the GUI 800 of FIG. 8 may be presented in the app. Here the user may navigate to the GUI 800 using any of the same methods described above in reference to navigation to the GUI 700 but to sort through individual images of objects as derived from the updated semantic map 720 (or map 300) and/or gathered from IoT camera input. The user may thus look, via the GUI 800, for untrained/unrecognized objects, user-labeled objects, and/or system-recognized objects to ascertain their last known locations within the area 200. Here, the GUI 800 presents the individual object images in the form of thumbnails 810 that are accompanied by respective text identifiers indicating the respective label for each object (if available). Depending on desired implementation, the user may then locate the corresponding real-world object itself by appreciating its current location from the thumbnail, by selecting the thumbnail to present a larger version of the thumbnail to appreciate the object's current location from the larger version, and/or by selecting the thumbnail to command the device/app to present an updated semantic map and indication of the object (like the map 720 and graphical indication 730 of FIG. 7). Additionally or alternatively, the user may provide voice input of a description of the object, and voice recognition may then be executed to further narrow down the user's search for the desired object (e.g., if multiple candidates exist, like multiple sets of car keys) and possibly present the map 720 and indication 730 once the intended object has been located.

Present principles may also be used for real-world object placement via map route planning. For example, suppose a cleaner or mover has been instructed by the premises' owner to move the couch 206 within the area 200 or to place a new couch within the area 200. The owner may manipulate the map 300 with his/her smart device to move object representations about and thus render an updated map where the logical position of the couch in the updated map does not yet correspond to the actual (current) real-world position of the couch but rather a desired future location of the couch. The owner may then send or otherwise grant access to the updated map to the cleaner or mover so that the map can be presented on the cleaner/mover device's display along with navigational assistance for placing the couch at the owner's desired location within the area 200.

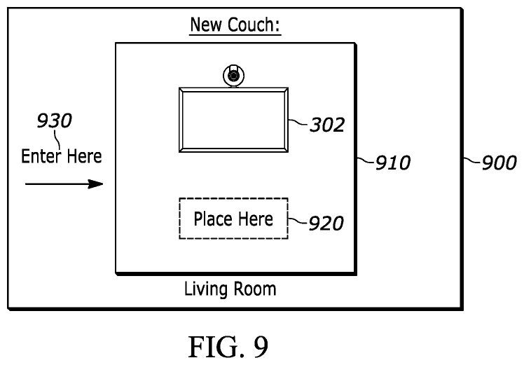

FIG. 9 therefore shows a GUI 900 with this updated semantic map 910. The map 910 shows a 3D location 920 designated by the owner for where the couch should be placed, and graphical navigational assistance 930 is also provided in the form of arrows directing the user to that spot. Similar but audible navigational assistance may also be provided, if desired. The assistance 930 may thus indicate how to enter the area (e.g., a direction from which to enter, such as through a front door) as well as indicate a path to where the couch should be placed and the real-world location itself at which to place the couch.

Thus, present principles make route planning inside a mappable space possible for recognized/labeled objects. The map created for that space can be visually presented to the user through the (e.g., purpose-built) viewing application, and users can then place objects recognized by the semantic map at preferred locations as indicated inside that map. This may be done utilizing any augmented reality device, mobile device, or other device that has access to the semantic map so that a navigational path may be created from the current location of the accessing device to the desired location of each object for placement/positioning by the user. This may be particularly useful when a user wants to place objects inside an unfamiliar space but needs help navigating the space, and it can be particularly useful for moving companies, cleaners, etc.

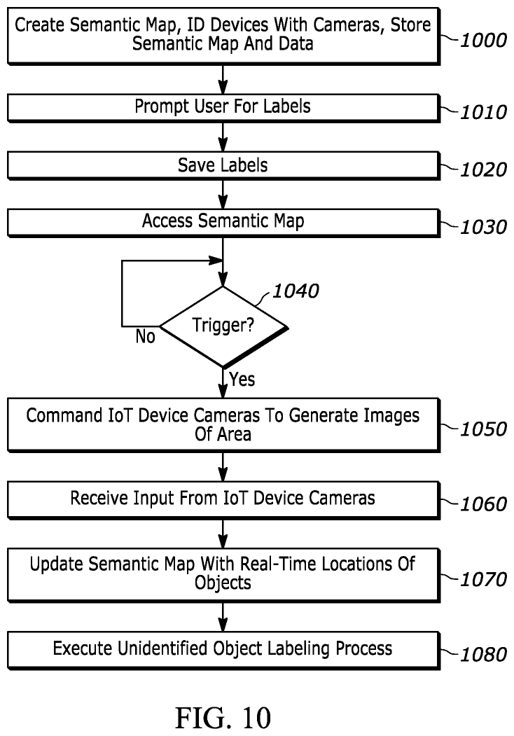

Now referring to FIG. 10, it shows example logic that may be executed by a device such as the system 100 and/or processor assembly 122 consistent with present principles. The logic of FIG. 10 may therefore be executed by one or multiple devices (e.g., client device and remotely-located server) in any appropriate combination. Note that while the logic of FIG. 10 is shown in flow chart format, other suitable logic may also be used.

Beginning at block 1000, the device(s) may create a semantic map and, during creation of the semantic map, identify one or more real-world devices in the mapped area that each include at least one camera (e.g., using communication with those devices to identify their specifications as indicating camera inclusion, using object recognition to identify the cameras themselves, etc.). Also at block 1000, the device may store the semantic map and other data (e.g., data indicating the one or more real-world devices that each include a camera, data indicating computer-derived labels for respective objects shown in the map as determined using object recognition, etc.). From block 1000 the logic may then proceed to block 1010.

At block 1010 the device may prompt an end-user for labels for any objects that the device was unable to identify via object recognition to then, at block 1020, receive user input of those labels and save those labels. This process may operate as already described above in reference to FIGS. 3-5. From block 1020 the logic may then proceed to block 1030.

At block 1030 the device may access the semantic map again at a later time and proceed to decision diamond 1040 where the device may determine whether one or more triggers exist to update the semantic map. The trigger(s) may include a recurring/threshold period of time ending, receipt of a user command to update the semantic map, and/or a determination using object recognition that part of a real-world space represented in the semantic map has changed (e.g., as might occur if a user is already using the semantic map for navigational assistance as described above). A negative determination may cause the logic to continue making the determination at diamond 1040 until an affirmative determination is made, or the logic might revert back to a previous block to proceed again therefrom, depending on implementation.

Then once an affirmative determination is made at diamond 1040, the logic may proceed to block 1050. Responsive to the affirmative determination at diamond 1040, at block 1050 the device command one or more Internet of things (IoT) devices already identified as having cameras at block 1000 to generate and provide updated images of the area indicated in the semantic map itself. The IoT devices may include, as non-limiting examples, a television, a smartphone, a tablet computer, a laptop computer, a headset, a stand-alone camera, a digital assistant device, a cooking appliance, an electronic door lock, and/or an electronic doorbell.

At block 1060 the device may thus receive the input (e.g., images) from one or more of the IoT device cameras to, at block 1070, update the semantic map based on the input so that the updated semantic map indicates the current real-time locations of the real-world objects within the area. Additionally, the updated semantic map may remove 3D data for objects that are determined to no longer be present in the area, and to include 3D data for additional objects that are currently located in the area but were not there when the initial semantic map was created at block 1000. Also note that the camera(s) used to update the semantic map may be the same as or different from the camera(s) used to create the initial semantic map at block 1000.

From block 1070 the logic may then proceed to block 1080, though block 1080 may additionally or alternatively be executed as part of block 1000 or immediately thereafter. In any case, at block 1080 the device may execute an unidentified object labeling process as set forth above with respect to FIGS. 3-5. Thus, as an example, at block 1080 the device may present a user interface indicating an object in the initial or updated semantic map that has not been identified via object recognition, receive user input indicating a label for the object, and update the semantic map with the label. The user interface might include a GUI as described above and/or an audible user interface (e.g., audible prompts provided to the user via a speaker on the user's device, to which the user may also respond audibly as detected via a microphone on the user's device).

Also at block 1080, the device may present a prompt for a user to use a camera to capture images of the unidentified object from different angles, receive the images of the unidentified object in response, generate three-dimensional (3D) data for the unidentified object based on those images, and update the semantic map with that 3D data as also already described above.

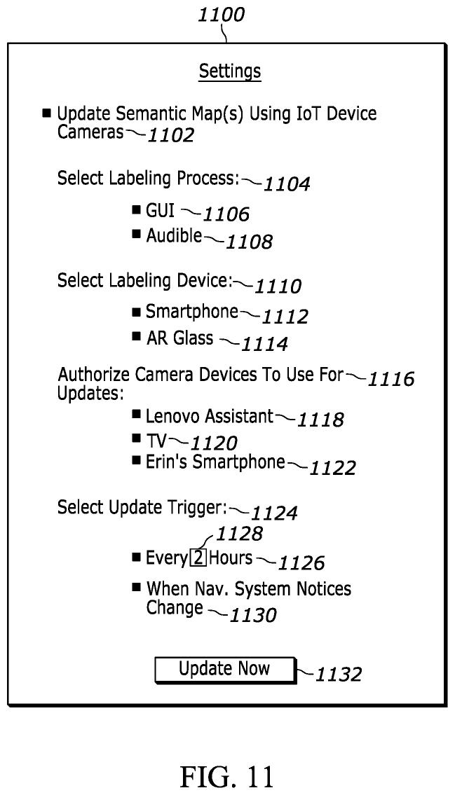

Continuing the detailed description in reference to FIG. 11, it shows an example settings GUI 1100 that may be presented on the display of a device configured to undertake present principles (e.g., a device executing a semantic mapping app consistent with present principles). The GUI 1100 may be presented to set or enable one or more settings of the device/app, and may might be navigated to through a device or app menu for example. Also note that each of the example options discussed below may be selected by directing touch or cursor input to the associated check box adjacent to the respective option.

As shown in FIG. 11, the GUI 1100 includes an option 1102 that may be selected to set or configure the device/app to undertake present principles. Thus, option 1102 may be selected a single time to set or enable the device/app to, in multiple future instances, update a semantic map as described above (and/or to perform other functions described above with respect to the figures above).

If desired, the GUI 1100 may also include a setting 1104 at which the user may select a preferred labeling process. The user may thus select option 1106 to label unidentified objects via a GUI, and option 1108 to label unidentified objects via audible interaction with the system as discussed above.

Also if desired, the GUI 1100 may include a setting 1110 for the end-user to select one or more specific devices to use for labeling objects that have not been identified via object recognition. Per the example shown, an option 1112 may be selected for the user to select his/her smartphone as the labeling device, and option 1114 may be selected for the user to select his/her AR headset/glasses to use as the labeling device.

Additionally, in some example embodiments the GUI 1100 may include a setting 1116 at which the user may select one or more devices with cameras to authorize as devices to use for semantic map updates. Per the example shown, an option 1118 may be selected to select a stand-alone digital assistant device to use (e.g., a Lenovo Assistant), option 1120 may be selected to use a television with its own camera to use, and an option 1122 may be selected to use the user's own smartphone.

Still further, the GUI 1100 may include a setting 1124 at which the user may select one or more triggers to use for semantic map updates. Accordingly, the GUI 1100 may include a first option 1126 that may be selected for semantic map updates, where the first option sets the device/app to update a semantic map at a recurring period of time (e.g., responsive to the recurring period of time ending). The recurring period of time itself may be specified by entering numerical input to input box 1128, and in the present instance has been set at two hours such that a semantic map is updated every two hours.

As also shown in FIG. 11, a second option 1130 may be included for the setting 1124. The second option 1130 may be selected to update a semantic map responsive to a determination using object recognition that part of a real-world space represented in the semantic map has changed. For instance, if the user or another person were using the semantic map and a smartphone to help place a couch at a particular location within the space as described above, and the smartphone determined based on the map that other objects are not currently at locations indicated in the map since their current locations as determined from camera input do not match map locations, the smartphone may trigger a semantic map update.

Additionally, if desired the setting 1124 may include a selector 1132 that may be selectable to update a semantic map immediately and responsive to the user's command via selection of the option 1132. Thus, the user is provided a way to update the semantic map at will at a time of his/her choosing.

Moving on from FIG. 11, it may therefore be appreciated that, among other things, principles set forth above may be used for tracking and/or placement of objects. A user might therefore say “Tell me where my blue cup is” and the device may audibly navigate the user to the blue cup using a current version of a semantic map with the real-time locations of various objects within the corresponding space. Present principles may also be used to place furniture somewhere specific or show a clearer a specific item to clean. A mover might also use the semantic map to guide them to where to set certain objects back at locations desired by the space's owner or renter (e.g., by presenting a previous, saved version of the semantic map) so that the mover can set things back a certain way according to a previous configuration of the room. A user can thus change the logical position of an object in map, but not real-world position, to then that instruct the mover to actually move the object to the desired location in the real-world.

Augmented reality (AR) and virtual reality (VR) implementations are also envisioned. As such, the GUIs and other aspects described above may be presented at AR/VR headsets and other types of headsets.

Route planning inside mappable spaces can also be provided, where the semantic map may be used to route a user to a current location of an object he/she is seeking. Thus, the semantic map may be accessed from the cloud and loaded into any desired smart device to direct the user to the item he/she is seeking.

Additionally, not only can a system operating consistent with present principles request that a user change locations of a certain camera to help get adequate coverage of a real-world space for semantic mapping to recreate the space via the map, but if the camera is subsequently moved again by the user, the user may be provided with a GUI that reminds the user to move the camera back to the previous location so that semantic map updates can be executed with adequate camera coverage as well.

Before concluding, note that any of the GUIs discussed above may be presented on headset display transparently or semi-transparently using alpha-blending, and/or may be presented opaquely on smartphone display or other non-transparent display (such as a non-transparent virtual reality headset display). Audible user interfaces may also be implemented on a variety of different device types, including headsets and mobile devices.

Also before concluding, note that objects may be labeled audibly as well as through a GUI if desired. For instance, an audible prompt may be presented to label a given object by current location rather than character, and then a user may provide an audible response as detected via a microphone and processed using speech recognition and natural language understanding to then apply a location-based label indicated in the audible input.

It may now be appreciated that additional electronic tags for each object need not be used for tracking objects within a space, providing a technical improvement as additional tracking devices and communication channels need not necessarily be used. Accordingly, present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
a processor assembly; and
storage accessible to the processor assembly and comprising instructions executable by the processor assembly to:
access a semantic map;
receive input from a first camera on an Internet of things (IoT) device; and
update, based on the input, the semantic map.

2. The first device of claim 1, wherein the instructions are executable to:
responsive to at least one trigger, command the IoT device to provide the input.

3. The first device of claim 2, wherein the at least one trigger comprises a recurring period of time ending.

4. The first device of claim 2, wherein the at least one trigger comprises receipt of a user command to update the semantic map.

5. The first device of claim 2, wherein the at least one trigger comprises a determination using object recognition that part of a real-world space represented in the semantic map has changed.

6. The first device of claim 2, wherein the instructions are executable to:
during creation of the semantic map, identify one or more real-world devices that each include a camera, the one or more real-world devices comprising the IoT device;
save data indicating the one or more real-world devices that each include a camera; and
use the data to command the IoT device to provide the input.

7. The first device of claim 1, wherein the instructions are executable to:
present a user interface (UI), the UI indicating an object in the semantic map that has not been identified via object recognition;
receive user input indicating a label for the object; and
update the semantic map with the label.

8. The first device of claim 7, wherein the instructions are executable to:
present a prompt for a user to use a second camera to capture images of the object from different angles;
receive the images of the object and generate three-dimensional (3D) data for the object based on the images; and
update the semantic map with the 3D data.

9. The first device of claim 8, wherein the second camera is different from the first camera.

10. The first device of claim 7, wherein the UI comprises a graphical user interface.

11. The first device of claim 7, wherein the UI comprises an audible user interface.

12. The first device of claim 1, comprising the camera.

13. The first device of claim 1, wherein the first device is different from IoT device.

14. A method, comprising:
accessing, via a first device, a semantic map;
receiving input from a first camera on a second device; and
updating, based on the input, the semantic map.

15. The method of claim 14, wherein the second device is an Internet of things (IoT) device.

16. The method of claim 15, wherein the IoT device comprises one or more of: a television, a smartphone, a tablet computer, a laptop computer, a headset, a stand-alone camera, a digital assistant device, a cooking appliance, an electronic door lock, an electronic doorbell.

17. The method of claim 14, comprising:
updating, at recurring periods of time, the semantic map using one or more cameras.

18. At least one computer readable storage medium (CRSM) that is not a transitory signal, the at least one CRSM comprising instructions executable by a processor assembly to:
access a semantic map;
receive input from a first camera on a device accessible to the at least one processor; and
update, based on the input, the semantic map.

19. The CRSM of claim 18, wherein the instructions are executable to:
request a label from a user for an object that cannot be recognized via object recognition, the object represented in the semantic map;
receive user input indicating the label; and
update the semantic map with the label.

20. The CRSM of claim 18, wherein the instructions are executable to:
trigger the first camera to generate the input for updating the semantic map, the first camera being triggered responsive to one or more of: user command, a recurring period of time ending.
